(19) United States
(12) Patent Application Publication
(10) Pub. No.: US 2008/0070223 A1
(43) Pub. Date: Mar. 20, 2008

(54) DATA COLLECTION SYSTEM AND METHOD

(75) Inventors: Carrie Lynn LOFKRANTZ, Newmarket (CA); Gordon Frank Ripley, Barrie (CA); Andrew Alan Payton, Mississauga (CA); Daniel Richard St. Germain, Aurora (CA)

Correspondence Address: DIMOCK STRATTON LLP, 20 QUEEN STREET WEST SUITE 3202, BOX 102, TORONTO, ON, M5H 3R3, US

(73) Assignee: CONSUMER CONTACT ULC, Toronto (CA)

(21) Appl. No.: 11/622,258

(22) Filed: Jan. 11, 2007

(30) Foreign Application Priority Data
Aug. 28, 2006 (CA) 2,557,344

(51) Int. Cl. G09B 3/00

(52) U.S. Cl. 434/350

(57) ABSTRACT

A method of data collection, comprises generating questions for response that include at least one data integrity trigger comprising a question or series of questions at least one response to which indicates an unconsidered response. Responses to the plurality of questions are obtained from a plurality of respondents, and each respondent's responses to the data integrity trigger questions are compared against trigger responses that indicate an unconsidered response. If a respondent's response to one or more integrity trigger questions indicates an unconsidered response, the respondent is flagged as suspect. The survey administrator can then optionally contact the suspect respondent to verify the accuracy of his or her responses, and/or discard the suspect respondent's responses.

### FIELD OF THE INVENTION

This invention relates to surveys. In particular, this invention relates to a system and method for data collection.

### BACKGROUND OF THE INVENTION

Surveys are widely used for business, government and institutional purposes. In a typical market research survey, a questionnaire is created by a survey administrator, data is collected in the form of responses to the questions in the questionnaire, and the data is assembled and analyzed using statistical methods to provide demographic and behavioural information relating to a variety of issues. The questions are selected according to the information sought to be obtained by the particular survey, which may include personal information, and personal behaviours such as buying habits or other information, and as such are designed to evoke answers which will provide information useful for analysis in the context of the survey's objectives.

Quality control, which in the case of a survey means the ability to assess the reliability of the collected data, is an extremely important factor in the quality or value of the survey itself. Every survey has an inherent unreliability because wrong (usually unconsidered) answers can be given by respondents, and it can be difficult to determine the extent of errors in the data collected for a particular survey.

The data must be collected through responses provided by survey respondents, and there is always the possibility that, for various reasons, a respondent's answers may not be accurate. Often an incentive (for example a financial reward) needs to be offered in order to entice respondents to give up their time and participate in the survey. Some of the respondents may only be interested in the incentive, and therefore less interested in ensuring the accuracy of their responses. Data collected from such a respondent is suspect, and erodes the data integrity of the responses to the survey overall. This leads to an inherent unreliability in the survey results.

This potential unreliability is considered when assessing survey results. However, it can be difficult to identify those respondents whose ulterior motivation for participating in the survey is likely to lead to inaccurate responses. This is particularly problematic in an on-line survey. Whereas telephone surveys are monitored by a quality team as the interview is being completed, and mall interviewers have direct personal contact with each respondent, so that these interviewers are able to identify obvious inaccuracies (such as a male respondent saying he is female), in an online survey there is no human interaction during the data collection period and thus it is easier for respondents to stretch the truth, or become distracted due to boredom.

While it is possible to speculate as to a margin for error that takes this into account, the reliability of the survey results would be necessarily enhanced if the ability to identify suspect responses were improved. Suspect responses can then be eliminated from the response data. Moreover, if a certain sample size is required, when suspect responses are identified a verification step can take place to validate the information. In these cases the integrity of the collected data would be considerably greater.

### BRIEF DESCRIPTION OF THE DRAWINGS

In drawings which illustrate by way of example only a preferred embodiment of the invention.

FIG. 1 is a flowchart showing the steps in a preferred embodiment of the method of the invention.

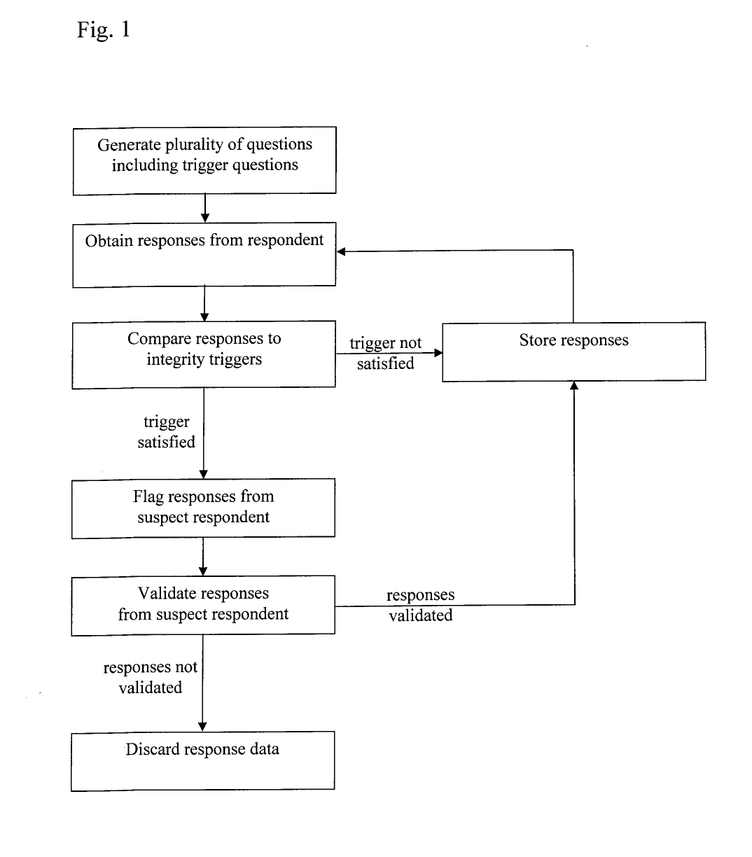

FIG. 2 is a system for performing the method of the invention.

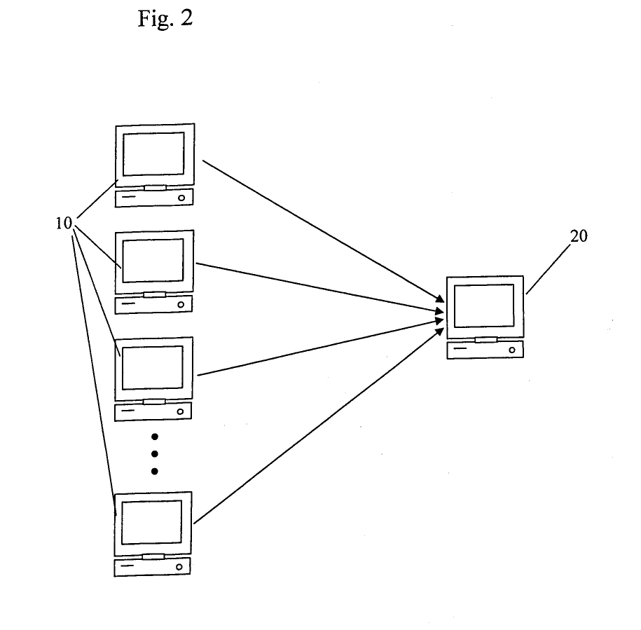

### DETAILED DESCRIPTION OF THE INVENTION

The system and method of the invention provides a quantitative method of providing a survey with a high degree of quality control and a discernable margin of error. The method of the invention is particularly suitable for use in surveys conducted online over a global computer network such as the Internet, where responses can be collected and validated in real time. This provides exceptional data integrity and thus more accurate survey results, and reduces the cost to the sponsoring organization because fewer respondents are required to obtain the same sample size of valid responses as in conventional surveying techniques.

The system and method of the invention can also be implemented in surveys conducted in other environments, since it is possible to discard suspect results to improve the reliability of the survey results even without the validation step of the preferred embodiment.

According to the method of the invention, a plurality of questions is generated for response by a plurality of respondents. The questions include at least one question or series of questions, the response to which is used as a data integrity trigger to indicate a suspect respondent.

According to the invention the survey is provided with at least one such data integrity trigger, preferably multiple data integrity triggers interspersed throughout the questions of the survey. The data integrity triggers are intended to assess the reliability of a respondent's responses to the survey questions generally.

The data integrity trigger can be in various forms, include the following by way of example only:
Straight lining—Where the responses to a series of questions are visually linear (i.e. roughly form a line) when shown on a page or user interface. This suggests a series of unconsidered responses.
Inter-question consistency—Where the response to one question should be identical to a response, or within the range of a response, given in another question. A response different from the response to the other question or outside this range, respectively, indicates an unconsidered response. Conversely, Where a pair of questions (preferably spaced well apart in the survey form) should evoke opposite answers, the same response to both questions indicates an unconsidered response.
Response duration—Where a series of questions should take at least a minimum amount of time to answer properly. A respondent spending less than the minimum amount of time indicates a series of unconsidered responses.
Overgrouping—Where a question requires that the respondent identify each case within the question that applies to the respondent's situation and it would be unrealistic for all cases to apply. A respondent responding that all cases apply indicates an unconsidered response.

These are examples of data integrity trigger questions designed to determine whether a particular respondent is giving due consideration to his or her responses. Depending on the number and nature of the data integrity triggers included in a survey questionnaire, the responses obtained from a particular respondent may be considered unreliable if any one of the triggers occurs, or if a certain portion (for example 3 out of 6) of the triggers occur in the respondent's responses.

According to the method of the invention, the survey administrator obtains responses to the plurality of questions from a plurality of respondents. This step can be effected by providing an online survey form accessible, for example, through a conventional browser program; by a telephone operator asking questions and transcribing the respondent's answers; by a survey document delivered to the respondent and returned with responses to the survey authority; or in any other suitable fashion.

Each respondent's responses to the data integrity trigger questions are compared to known data integrity trigger responses that would indicate an unconsidered response. If the response to any data integrity trigger question, or to a pre-selected number of data integrity trigger questions, or to a specific data integrity trigger question (depending upon the threshold established by the survey administrator), indicates an unconsidered response or a series of unconsidered responses, the respondent is flagged as a suspect respondent and all responses from the suspect respondent are treated suspect.

The suspect responses can be removed from the obtained responses immediately, or a verification procedure (for example, contacting the suspect respondent by telephone to determine why the trigger responses were given) can be undertaken before the suspect responses are removed from the obtained responses. Alternatively, a verification step may be undertaken only if there are less than a selected number of trigger responses in the respondent's responses, and respondents whose responses satisfy greater than the selected number of trigger responses can be discarded without verification, either immediately or, preferably, following review by a verifying authority such as a quality control department staffed with trained personnel. In the preferred embodiment, a set of responses is discarded only after verification by a quality control department and other personnel associated with the survey.

In the preferred embodiment the administrator will manually review all questions of any suspect survey for flow, logic and nature of content. The administrator will contact the respondent by telephone if required (and allowed) to resolve any apparent anomalies and/or decide whether to disregard the survey results.

In the preferred embodiment a system is provided for performing the method of the invention. Responses are entered either directly by a recipient, or for example in the case of a telephone survey the responses may be entered by a representative of the survey administrator, into a data input device 10 such as personal computer (PC). The responses are communicated (for example, over the Internet) to a survey administrator's computer 20, for example any general purpose computer such as a personal computer, equipped with suitable software for storing and tabulating responses. The software comprises programming that identifies data integrity trigger responses and compares them against stored data integrity trigger responses that would indicate an unconsidered response, and flags a respondent's status as suspect if the comparison finds the required number of matches. The survey administrator can then follow up with the respondent, or discard the respondent's results, to improve the reliability of the results of the survey.

Thus, in one embodiment of the invention the collected data can be evaluated in real time, with the survey administrator or a suitably programmed computer flagging and segregating each suspect respondent's responses as they are received and, in the preferred embodiment, the survey administrator can then undertake a verification step in respect of some or all suspect respondents to determine whether their responses are valid.

The system of the invention may be implemented on a conventional PC using available market research software, for example Net-MR (Trademark) by GMI. Quality control questions may be identified on a Specification Sheet under “Additional Validation Questions.” The Specification Sheet preferably also states how many quality control conditions have to be triggered before setting off a quality control alert, i.e. flagging a survey as suspect. The triggers should be displayed on the Specification Sheet in order of the question numbers, for easy reference by the reviewer.

The required variables and logic to catch the trigger condition are set up for each trigger question by the administrator. The variable, for example “$QT#” (where # is the number of the quality trigger in the Specification Sheet), is used to determine if the quality control condition will be needed later in the quality control alert. If a trigger condition is met, then the questioner populates the trigger variable field with the error type (e.g. “Straight Lined”, “Less than 25 seconds”, etc.) The logic to detect the trigger is dependent upon the nature of the trigger selected for that question. For example, in a question where selecting more than 9 possible answers activates the trigger, the trigger condition can be represented by the function:

B:FUNC[$QT1:”]
A:$CURRENT_RESPONSE_NUMBER>9 FUNC[$QT1:‘10 OR
MORE SELECTED’]

On the last page of the survey the reviewer will determine how many quality control conditions were met. For each condition met a trigger variable ($QT_TOT#) must be implemented and the trigger variables are summed to determine whether the threshold number of triggers has been met. These statements may be setup as, for example:

```
B:FUNC[$QT_TOT:”]
  $QT1!=“ FUNC[$QT_TOT:$QC_TOT+1]
  $QT2!=“ FUNC[$QT_TOT:$QC_TOT+1]
```

In the preferred embodiment, on the last page of the questionnaire the administrator can define an email trigger which is activated if the value of the trigger variable is equal to or greater than the preset number of quality control triggers that have to be satisfied before setting off a quality control alert. This can be accomplished as follows:
a. To define an email trigger, click on the link in the top right hand corner of the Branch Logic Section—“Set Email Trigger”.
b. Set the title—QC ALERT/CC [CC#]
c. Set TO—[email address of quality control department]
d. Set FROM—[email address of reviewer]
e. Set CC—[email address of team project directors] (optional)
f. Set Subject—QC ALERT/CC [CC#]
   The email text begins with “Respondent #[USER_ID]<br>”. The rest of the message text will include headings for each quality control condition, followed by the value of the quality control variable for that condition. For example:

<p>Respondent #[USER_ID]
<p>[$QC_TOT] Triggers have been set-off
<p>Q2 : [$QC1]
<p>Q13: [$QC2]
<p>Q15: [$QC3]
<p>Q19: [$QC4]
<p>C1–C6: [$QC5]
(no value means no straight-line response)

g. Insert HTML tags for formatting into the email text.
h. Once complete, click “Add New” then “Select and Close.”
i. On the condition line will appear SENDEMAIL(X), where X is the email trigger number. On this line the logic required to activate the SENDEMAIL command is defined.
For example, where the trigger is set to be sent if two or more conditions are met, the SENDMAIL command will read:
   $QT_TOT>=2 SENDEMAIL(10)

In the preferred embodiment, a listing of all quality control variables relating to the survey and the number of triggers met by each respondent is stored in a database, to facilitate a review of the results.

Various embodiments of the present invention having been thus described in detail by way of example, it will be apparent to those skilled in the art that variations and modifications may be made without departing from the invention. The invention includes all such variations and modifications as fall within the scope of the appended claims.

We claim:

1. A method of data collection, comprising the steps of:
a. generating a plurality of questions for response, including at least one data integrity trigger comprising a question or series of questions at least one response to which indicates an unconsidered response; and,
b. in any order:
i. obtaining responses to the plurality of questions from a plurality of respondents;
ii. comparing each respondent's response to the at least one data integrity trigger against a trigger response selected to indicate an unconsidered response, and
iii. if a respondent's response to the at least one integrity trigger indicates an unconsidered response, flagging the respondent as suspect.

2. The method of claim 1 including after step b(iii) the further step of:
c. contacting the suspect respondent to verify the accuracy of responses from the suspect respondent.

3. The method of claim 1 including after step b(ii) the further step of removing all of the suspect respondent's responses from the obtained responses.

4. The method of claim 2 including after step b(iii) the further step of removing all of the suspect respondent's responses from the obtained responses.

5. The method of claim 1 wherein in step b(iii) the respondent is flagged as suspect if a pre-selected number of the respondent's responses to data integrity trigger questions indicates an unconsidered response.

6. The method of claim 1 wherein a notification of each respondent flagged as suspect is automatically sent to a verifying authority.

7. A system for data collection, comprising
a questionnaire comprising a plurality of questions for response, including at least one data integrity trigger comprising a question or series of questions at least one response to which indicates an unconsidered response; and
a computer for obtaining responses to the plurality of questions from a plurality of respondents, comparing each respondent's response to the at least one data integrity trigger against the at least one response which indicates an unconsidered response, and if a respondent's response matches the at least one response which indicates an unconsidered response, flagging the respondent as suspect.

8. The system of claim 7 further comprising a messaging system for automatically generating a notification of each respondent flagged as suspect and sending the notification to a verifying authority.
